(19) United States
(12) Patent Application Publication
(10) Pub. No.: US 2024/0364120 A1
(43) Pub. Date: Oct. 31, 2024

(54) POWER MANAGEMENT IN A POWER TOOL

(71) Applicant: MILWAUKEE ELECTRIC TOOL CORPORATION, Brookfield, WI (US)

(72) Inventors: Peter J. Wawer, Wauwatosa, WI (US); Donald J. Truettner, Waukesha, WI (US); Daniel R. Ertl, Kewaskum, WI (US)

(21) Appl. No.: 18/691,800

(22) PCT Filed: Sep. 23, 2022
(86) PCT No.: PCT/US2022/044494

§ 371 Date: Mar. 13, 2024

Related U.S. Application Data
(60) Provisional application No. 63/247,447, filed on Sep. 23, 2021.

(51) Int. Cl. H02J 7/00; B25F 5/00

(52) U.S. Cl. CPC H02J 7/0013; H02J 7/0031; H02J 7/007; B25F 5/00; H02J 2207/20

(57) ABSTRACT

Embodiments described herein provide power management systems including a battery pack powered tool, one or more battery packs coupled to the battery pack powered tool, a first plurality of sub circuits including a switch and one or more first peripheral outputs, and a second plurality of sub circuits including a voltage regulator and one or more second peripheral outputs. The systems also include one or more control lines for enabling or disabling the first plurality of sub circuits and the second plurality of sub circuits.

### RELATED APPLICATIONS

This application is a divisional of and claims priority to U.S. Provisional Patent Application No. 63/247,447, filed Sep. 23, 2021, the entire content of which is hereby incorporated by reference.

### FIELD

The present disclosure relates to battery pack powered devices, and more particularly to battery pack powered tools or accessories.

### SUMMARY

Embodiments described herein provide power management systems including a battery pack powered tool, one or more battery packs coupled to the battery pack powered tool, a first plurality of sub circuits including a switch and one or more first peripheral outputs, and a second plurality of sub circuits including a voltage regulator and one or more second peripheral outputs. The systems also include one or more control lines for enabling or disabling the first plurality of sub circuits and the second plurality of sub circuits.

In some aspects, the one or more battery packs include a first battery pack and a second battery pack.

In some aspects, the first plurality of sub circuits includes a high side switch connected to at least one of a pulse width modulation (“PWM”) driver, a memory, or one or more indicators.

In some aspects, the second plurality of sub circuits includes a low dropout (“LDO”) voltage regulator connected to at least one of a one or more sensors or a communication line.

In some aspects, the systems also include a switched-mode power supply (“SMPS”) configured to provide power from the one or more battery packs to the first plurality of sub circuits and the second plurality of sub circuits.

In some aspects, the SMPS is a buck converter.

In some aspects, the systems also include a processing unit configured to control at least one of the one or more control lines for enabling or disabling the first plurality of sub circuits and the second plurality of sub circuits.

In some aspects, the systems also include a control switch to control at least one of the one or more control lines for enabling or disabling the first plurality of sub circuits.

In some aspects, enabling or disabling the first plurality of sub circuits and the second plurality of sub circuits reduces quiescent current of the battery powered tool to less than 7 micro-Amps.

In some aspects, the systems also include one or more low equivalent series resistance (“ESR”) output capacitors, a buffer capacitor, and a series resistor connected between the ESR output capacitors and the buffer capacitor.

Embodiments described herein provide a method for managing power consumption of a battery pack powered tool. The method includes receiving, with a controller, power from one or more battery packs. The one or more battery packs are coupled to the battery pack powered tool. The method also includes providing, with the controller, the power from the one or more battery packs to a first plurality of sub circuits of the battery pack powered tool. The first plurality of sub circuits includes a switch and one or more first peripheral outputs. The method further includes providing, with the controller, the power from the one or more battery packs to a second plurality of sub circuits of the battery pack powered tool. The second plurality of sub circuits includes a voltage regulator and one or more second peripheral outputs. The method also includes controlling, with the controller, operation of the battery pack powered tool. The operation is to enable or disable the first plurality of sub circuits and the second plurality of sub circuits using one or more control lines.

In some aspects, the one or more battery packs include a first battery pack and a second battery pack.

In some aspects, the first plurality of sub circuits includes a high side switch connected to at least one of a pulse width modulation (“PWM”) driver, a memory, or one or more indicators.

In some aspects, the second plurality of sub circuits includes a low dropout (“LDO”) voltage regulator connected to at least one of a sensor or a communication line.

In some aspects, controlling operation of the battery pack powered tool includes controlling, with the controller, a switched-mode power supply (“SMPS”) to provide the power from the one or more battery packs to the first plurality of sub circuits and the second plurality of sub circuits.

In some aspects, the SMPS is a buck converter.

In some aspects, enabling or disabling the first plurality of sub circuits and the second plurality of sub circuits reduces quiescent current of the battery pack powered tool to less than 7 micro-Amps.

In some aspects, controlling the operation of the battery pack powered tool includes determining, with the controller, that the battery pack powered tool is not in use, and sending, with the controller, a control signal over the one or more control lines that disables the first plurality of sub circuits and the second plurality of sub circuits.

In some aspects, controlling the operation of the battery pack powered tool includes determining, with the controller, that the battery pack powered tool is in use, and sending, with the controller, a control signal over the one or more control lines that enables the first plurality of sub circuits and the second plurality of sub circuits.

Embodiments described herein include a battery pack powered tool. The battery pack powered tool includes a battery pack interface configured to receive a battery pack, a first sub circuit including a switch and a first peripheral output, a second sub circuit including a voltage regulator and a second peripheral output, and one or more control lines configured to enable or disable the first sub circuit and/or the second sub circuit.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the disclosure will become apparent by consideration of the detailed description and accompanying drawings.

### BRIEF DESCRIPTION OF THE DRAWINGS

FIG. 1 is a perspective view of a power tool, such as a handheld blower, with optional attachments, according to embodiments disclosed herein.

FIG. 2 illustrates a battery pack for the power tool of FIG. 1, according to embodiments described herein.

FIG. 3 illustrates a control system for the power tool of FIG. 2, according to embodiments described herein.

FIG. 4 illustrates a voltage control diagram for the power tool of FIG. 2, according to embodiments described herein.

FIGS. 5A and 5B illustrate circuit diagrams for power management, according to embodiments described herein.

FIG. 6 illustrates a process for managing power consumption of the power tool of FIG. 1, according to embodiments described herein.

### DETAILED DESCRIPTION

Generally, the present disclosure relates to a power management system for battery packs coupled to a battery pack powered device, such as a power tool or accessory. The battery pack powered device can be designed to receive one or more battery packs (e.g., two battery packs) which are each managed for longevity while coupled to the device. It may be beneficial for battery pack powered devices to keep their current consumption to a minimum value to ensure extended battery life of the connected battery packs and to avoid premature battery pack failure due to over-discharge events, in particular, for lithium-ion battery packs. For some devices, it may be preferable to keep standby current consumption to <7 micro-Amps (“uA”) for the battery packs. The standby current consumption can be managed by being able to shut-off, disconnect, or otherwise disable sub circuits or whole groups of sub circuits of the battery pack powered device. By deactivating the sub circuits with pull-up resistor values below 1 Megaohm, the overall quiescent current consumption of the circuits is reduced when the product is not in use.

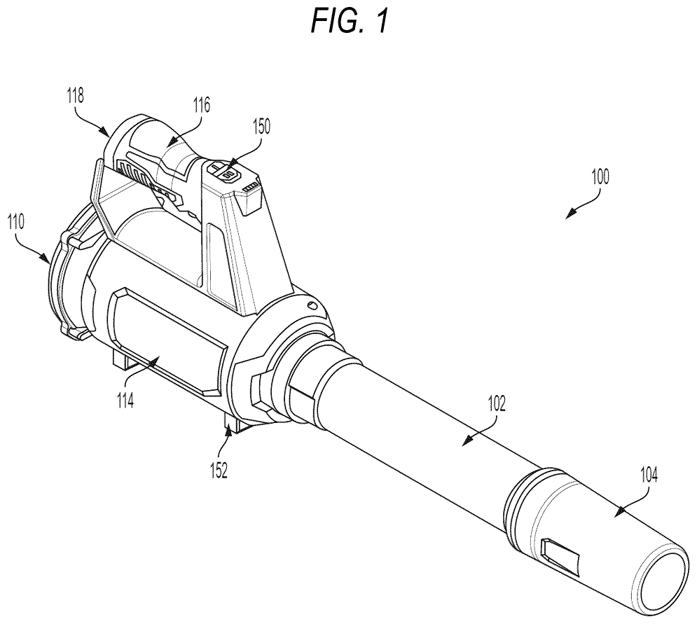

In some embodiments, the present disclosure can be implemented in a battery pack powered power tool or accessory. FIG. 1 provides an example battery pack powered tool 100 being a handheld blower for implementing the features of the present disclosure. Although the present disclosure is discussed with respect to a battery powered handheld blower, the present disclosure can be implemented using any combination of battery pack powered tools 100 or accessories without departing from the scope of the present disclosure. For example, the present disclosure can be implemented in any combination of cutting tools, drilling tools, lawncare tools, lighting accessories, audio/visual accessories, generators, etc.

FIG. 1 generally illustrates the handheld blower with three attachments including an extension 102 and a nozzle 104. Each of the extension 102 and the nozzle 104 is configured to removably connect to the outlet 108 of the handheld blower 100. The nozzles 104 is also configured to removably connect to the extension 102. The handheld blower 100 further includes an inlet 110 opposite from and upstream of the outlet 108. In the illustrated embodiment, a grate is disposed over the inlet 110 in order to prevent larger debris from entering the inlet 110. The grate may be a structure creating a series of slits, a screen, a circuitous flow path, or the like. The handheld blower 100 includes an air duct fluidly communicating the inlet 110 with the outlet 108 and extending along a longitudinal axis. The air duct is surrounded at least partially by a housing 114 of the battery pack powered tool 100. In some embodiments, the housing 114 may include two clamshell halves that are joined together with fasteners to surround the air duct. The handheld blower further includes a handle 116. In some embodiments, the handle 116 extends generally parallel to the longitudinal axis.

In some embodiments, the housing 114 and/or the handle 116 may include a battery pack interface or battery pack receiving cavity 118 defined therein. In the illustrated embodiment, the battery pack receiving cavity 118 also extends generally parallel to the longitudinal axis. The battery pack receiving cavity 118 can be configured to receive at least a portion of one or more battery packs. While at least a portion of the battery pack is received in the battery pack receiving cavity 118 in an operational position, at least another portion of the battery pack can be disposed outside of the battery pack receiving cavity 118 (in a direction generally rearwardly of the handle 116 in the illustrated embodiment). The portion of the battery pack outside of the battery pack receiving cavity 118 is disposed radially outwardly from the longitudinal axis at a position that is above the inlet 110. With the battery pack within the battery pack receiving cavity 118, electrical communication can be established between the battery pack and the battery pack powered tool 100. The electrical communication link can be used to provide power from the battery pack to the battery pack powered tool 100, as well as allowing the battery pack powered tool 100 to manage the battery usage.

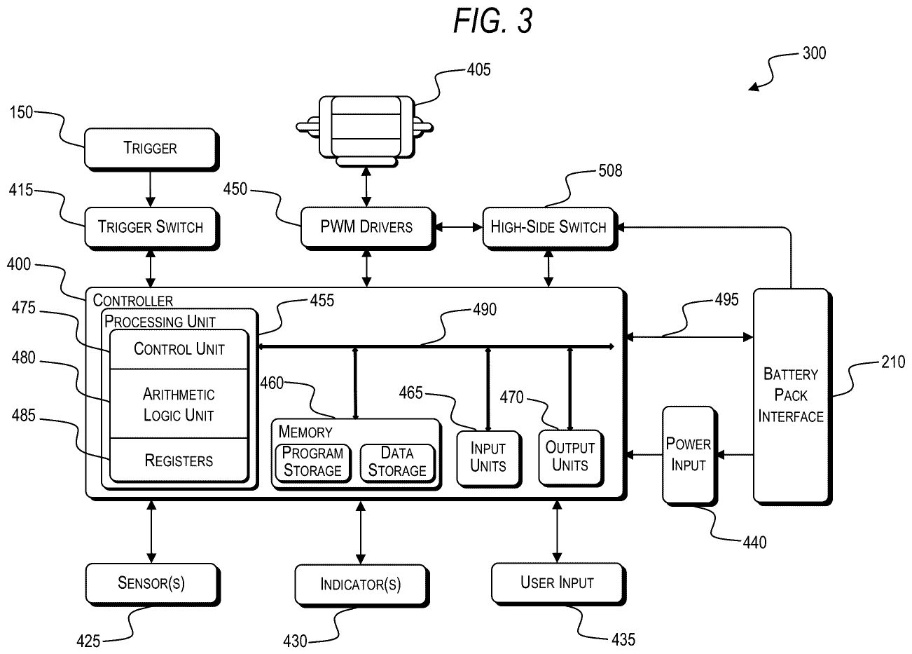

In some embodiments, the battery packs may be any combination of 12-volt, 18-volt, 36-volt, 40V, 80V, etc., battery packs. In some embodiments, the battery pack receiving cavity 118 can be designed to receive two 18-volt battery packs to provide, for example, a combined 36-volts to the battery pack powered tool 100. The battery pack(s) are provided to provide power to the battery pack powered tool 100 and its various components. In some embodiments, the battery pack(s) can provide a power source for the motor (for powering a fan of the blower), a microcontroller (e.g., controller 400 of FIG. 3) pulse width modulation (PWM) drivers 450 (e.g., a FET switching bridge) for the motor, memory 460 (e.g., a solid state drive [SSD]), indicators 430, various sensors 425, and any other combination of electrical components used by the battery pack powered tool 100. In some embodiments, one of the 18-volt battery packs can be designed to power a first sub-group of components while the combination of two 18-volt battery packs can be designed to power a second sub-group of components within the battery pack powered tool 100, as discussed in greater detail below.

The illustrated battery pack powered tool 100 (e.g., handheld blower) may include many other features including, for instance, one or more triggers 150 or other controls disposed on or about the handle 116, a plurality of support feet 152 to allow a user to place the handheld blower on a support surface, a plurality of vibration dampening sections (made of, for instance, a polymer material) connecting the air duct to the housing 114, a plurality of nozzle attachments and extension attachments of various shapes, sizes, and lengths, or the like.

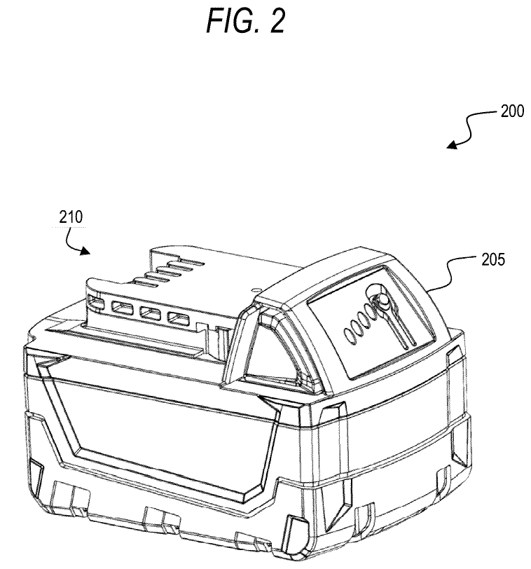

Referring to FIG. 2, a battery pack 200 including a housing 205 and battery pack interface 210 for connecting the battery pack 200 to a device (e.g., a battery pack powered tool 100) is depicted. The discharge of the battery pack 200 can be controlled by any combination of a battery pack controller, a power tool, a battery pack charger, etc., as provided by the present disclosure. The battery pack 200 can be an 18-volt or 36-volt battery pack, although other voltages between 12-volts and 120-volts are contemplated. The battery pack interface 210 includes a combination of mechanical components (e.g., rails, grooves, latches, etc.) and electrical components (e.g., one or more terminals) configured to and operable for interfacing (e.g., mechanically, electrically, and communicatively connecting) the battery pack powered tool 100 with the battery pack 200. For example, power provided by the battery pack 200 to the battery pack powered tool 100 is provided through the battery pack interface 210 to the power input module 440 (see FIG. 3). The power input module 440 includes combinations of active and passive components to regulate or control the power received from the battery pack 200 prior to power being provided to the controller 400. The battery pack interface 210 also supplies power to the PWM drivers 450 to selectively provide power to the motor 405. The battery pack interface 210 also includes, for example, a communication line 495 for provided a communication line or link between the controller 400 and the battery pack 200.

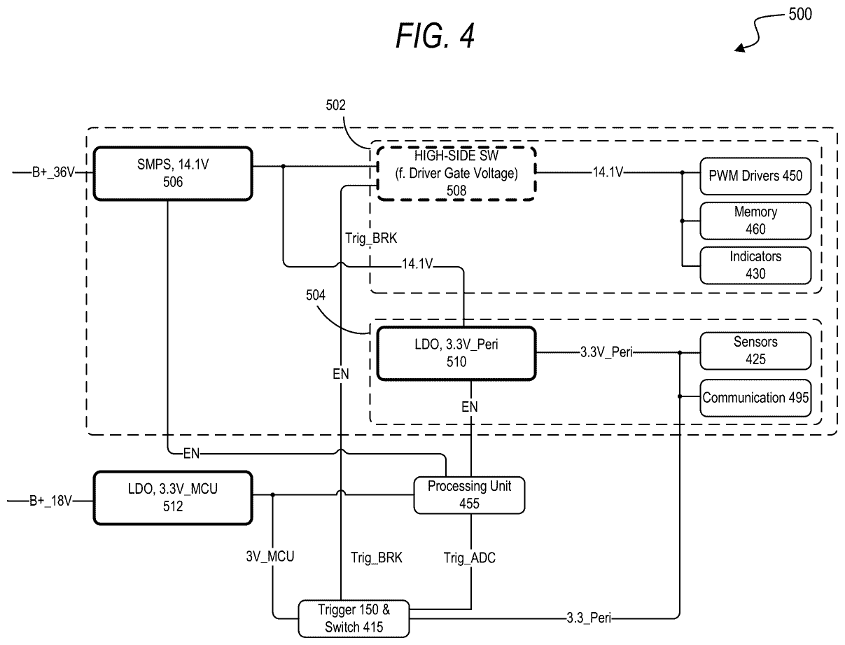

FIG. 3 illustrates an example control system 300 for a battery pack powered device (e.g., a battery pack powered tool 100). The control system 300 includes a controller 400 electrically and/or communicatively connected to a variety of modules or components of the battery pack powered tool 100. For example, the illustrated controller 400 is electrically connected (e.g., directly, indirectly via various subcircuits, etc.) to a motor 405, a battery pack interface 210, a trigger switch 415 (connected to a trigger 150), one or more sensors 425 or sensing circuits (e.g., one or more current sensors, one or more speed sensors, one or more Hall Effect sensors, one or more temperature sensors, etc.), one or more indicators 430, a user input module 435, a power input module 440, (PWM) drivers 450 (or a field effect transistor [FET] module including a plurality of switching FETs in a bridge configuration), and a high-side switch 508 (see FIG. 4). The controller 400 includes combinations of hardware and software that are operable to, among other things, control the operation of the battery pack powered tool 100, monitor the operation of the battery pack powered tool 100, activate the one or more indicators 430 (e.g., light emitting diodes (LEDs), etc.

In some embodiments, the controller 400 includes a plurality of electrical and electronic components that provide power, operational control, and protection to the components and modules within the controller 400 and/or the battery pack powered tool 100. For example, the controller 400 includes, among other things, a processing unit 455 (e.g., a microprocessor, a microcontroller, an electronic processor, an electronic controller, or another suitable programmable device), a memory 460, input units 465, and output units 470. The processing unit 455 includes, among other things, a control unit 475, an arithmetic logic unit (“ALU”) 480, and a plurality of registers 485 (shown as a group of registers in FIG. 3), and is implemented using a known computer architecture (e.g., a modified Harvard architecture, a von Neumann architecture, etc.). The processing unit 455, the memory 460, the input units 465, and the output units 470, as well as the various modules or circuits connected to the controller 400 are connected by one or more control and/or data buses (e.g., common bus 490). The control and/or data buses are shown generally in FIG. 3 for illustrative purposes. The use of one or more control and/or data buses for the interconnection between and communication among the various modules, circuits, and components would be known to a person skilled in the art in view of the invention described herein.

The memory 460 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, SSD, an SD card, or other suitable magnetic, optical, physical, or electronic memory devices. The processing unit 455 is connected to the memory 460 and executes software instructions that are capable of being stored in a RAM of the memory 460 (e.g., during execution), a ROM of the memory 460 (e.g., on a generally permanent basis), or another non-transitory computer readable medium such as another memory or a disc. Software included in the implementation of the battery pack powered tool 100 can be stored in the memory 460 of the controller 400. The software includes, for example, firmware, one or more applications, program data, filters, rules, one or more program modules, and other executable instructions. The controller 400 is configured to retrieve from the memory 460 and execute, among other things, instructions related to the control processes and methods described herein. In other constructions, the controller 400 includes additional, fewer, or different components.

The indicators 430 include one or more visual, audio or haptic feedbacks to provide feedback to a user as of the status of the battery pack powered tool 100 and/or battery pack 200. For example, indicators 430 can include one or more light-emitting diodes (“LEDs”). The indicators 430 can be configured to display conditions of, or information associated with, the battery pack powered tool 100. For example, the indicators 430 are configured to indicate measured electrical characteristics of the battery pack powered tool 100, the status of the battery pack(s) 200, etc. The user input module 435 is operably coupled to the controller 400 to, for example, select a forward mode of operation or a reverse mode of operation, a torque and/or speed setting for the battery pack powered tool 100 (e.g., using torque and/or speed switches), etc. In some embodiments, the user input module 435 includes a combination of digital and analog input or output devices required to achieve a desired level of operation for the battery pack powered tool 100, such as one or more knobs, one or more dials, one or more switches, one or more buttons, one or more touch or pressure sensitive sensors, etc.

In some embodiments, the controller 400 can include one or more power management systems for controlling power draw from one or more sub-systems of the battery pack powered tool 100, for example, as depicted in FIG. 4. Referring to FIG. 4, an example voltage control diagram 500 is depicted for implementing a power management system of the present disclosure. The voltage control diagram 500 includes a first plurality of sub circuits 502 for operating the battery pack powered tool 100 and its various peripheral components thereof. Examples for the first plurality of sub circuits 502 can include indicators 430, memory 460, PWM drivers 450, and any additional circuits for operation of the battery pack powered tool 100. The first plurality of sub circuits 502 can include a high side switch 508 (or other switch) to provide voltage to the components of the first plurality of sub circuits 502. The high side switch 508 can be a highly integrated power switch used to connect and disconnect the power source from the load of the components. For example, as depicted in FIG. 4, the high side switch 508 can connect and disconnect the power source from the PWM drivers 450, memory 460, and indicators 430. Using a load switch instead of a regular MOSFET offers several advantages including simplified design, small footprint, and protection features. In some embodiments, the first plurality of sub circuits 502 (indicators 430, memory 460, PWM drivers 450, and high side switch 508) can be disabled by sending a deactivation or disable signal to the high side switch 508, as discussed in greater detail herein.

The voltage control diagram 500 also includes a second plurality of sub circuits 504 for operating the battery pack powered tool 100 and its various peripheral components thereof. Examples for the second plurality of sub circuits 504 can include one or more sensors 425, communication line 495, and any additional circuits for operation of the battery pack powered tool 100. The second plurality of sub circuits 504 can include a voltage regulator 510 (e.g., a low dropout voltage regulator, etc.) to provide voltage to the components of the second plurality of sub circuits 504. The voltage regulator 510 is used to provide a stable power supply voltage independently of the state of battery charge. For example, as a battery drops from 14.1 V to an almost fully discharged level, the voltage regulator 510 can maintain a constant 3.3 V at the load (the sensors 425 and communication line 495). In some embodiments, the second plurality of sub circuits 504 (one or more sensors 425, communication line 495, and voltage regulator 510) can be disabled by sending a deactivation or disable signal to the voltage regulator 510, as discussed in greater detail herein. Although the present disclosure is discussed with respect to two sets of sub circuits with example peripherals, any number of sub circuits and peripherals could be used without departing from the scope of the present disclosure.

In some embodiments, power from one or more of multiple battery packs 200 can be provided to power the first plurality of sub circuits 502 and the second plurality of sub circuits 504. The power management system can be designed such that a combination of battery packs 200 can be used for powering the sub circuits 502, 504. For example, a combination of two 18V battery packs 200 can be used in combination and/or individually to power the different sub circuits 502, 504.

In some embodiments, a switched-mode power supply (“SMPS”) 506 can be provided to provide power from the battery pack(s) 200 to the high side switch 508 and voltage regulator 510. The SMPS 506 transfers power from the battery pack(s) 200 to the components (e.g., PWM drivers, memory, indicators, sensors, communication, etc.) of the first and second plurality of sub circuits 502, 504 through a combination of switches and voltage regulators. The SMPS 506 can provide power to the high side switch 508 and the voltage regulator 510 which then convey the appropriate power to the components attached thereto in a controlled manner. For example, the switching-mode supply continually switches between low-dissipation, full-on, and full-off states, and spends very little time in the high dissipation transitions, which minimizes wasted energy. In some embodiments, the SMPS 506 can be a buck converter that steps down voltage from the battery pack(s) 200 to the first plurality of sub circuits 502 and the second plurality of sub circuits 504. For example, the SMPS 506 can step down the voltage from a first voltage (e.g., 36V) to a second voltage (e.g., 14.1V).

In some embodiments, the SMPS 506, the high side switch 508, and the voltage regulator 510 can each include an enable pin for turning the control of the switches and/or regulators on or off. The enable pins can be coupled to control lines connected to a combination of the processing unit 455, the trigger 150, and/or switch 415. The processing unit 455, the trigger 150, and/or switch 415 can provide enable and/or disable signals depending on how the power management system is configured. As depicted in FIG. 4, in some embodiments, the processing unit 455 can be coupled to control lines for the SMPS 506 and the voltage regulator 510, while the trigger 150 and/or switch 415 can be coupled to a control line for the high side switch 508. Depending on operation of the battery pack powered tool 100, the different control lines can be activated/deactivated to control load from the respective sub circuits. The control lines may be analog, digital, and/or any other communication type, and control lines that may, but are not limited to, enable or disable the circuits that source and/or control the supply voltage to multiple cascaded sub circuits at once or individual sub circuit groups individually. For example, the first plurality of sub circuits 502 and the second plurality of sub circuits 504 can be arranged in a cascaded manner in which deactivation of the SMPS 506 will result in the deactivation of both the first and second plurality of sub circuits 502, 504. Using the control lines, improvement to the longevity and operation of the battery packs 200 connected to the battery pack powered tool 100 can be achieved because they lower the current consumption of the battery pack(s) 200 by deactivating circuits when they are not in use. Additionally, the longevity and operation of the battery packs 200 can be improved through a combination of power sequencing and quiescent current saving for battery shelve life extension.

In some embodiments, the power management system can include the processing unit 455, the trigger 150, and/or switch 415 can control activation and deactivation of the sub circuits 502, 504. The processing unit 455 and trigger 150 and/or switch 415 can be coupled to a voltage regulator 512 to receive power from the battery packs 200. The voltage regulator 512 can be the same or different from the voltage regulator 510. The processing unit 455 and the trigger 150 and/or switch 415 may not require power from all of the battery packs 200. For example, the processing unit 455 and the trigger 150 and/or switch 415 may only need power from one of the 18-volt battery packs 200 coupled to the battery pack powered tool 100. In some embodiments, the processing unit 455 can be coupled to the control lines for the voltage regulator 510 and the SMPS 506 while the trigger 150 and/or switch 415 can be coupled to the control line for the high side switch 508. The trigger 150 and/or switch 415 can also be coupled to the processing unit 455 and the components (sensors 425, communication 410) for the second plurality of sub circuits 504. The control lines between the processing unit 455, the second plurality of sub circuits 504, and the trigger and/or switch 415 can be provided to control when the various control lines are activated/deactivated. The enable lines can be used to disable either of the sub circuits 502, 504 individually or both circuits by disabling the SMPS 506, as discussed in greater detail below.

By disabling or deactivating one or both of the sub circuits 502, 504, or the whole battery pack powered tool 100, a power saving mode is implemented lowering the quiescent current to below a threshold value (e.g., less than 7 uA). Specifically, being able to shut-off/disconnect/disable one of the first or second plurality of sub circuits 502, 504 or whole groups of sub circuits 502, 504 with pull-up resistor values below 1 Megaohm reduces the overall quiescent current consumption of the circuits when the product is not in use.

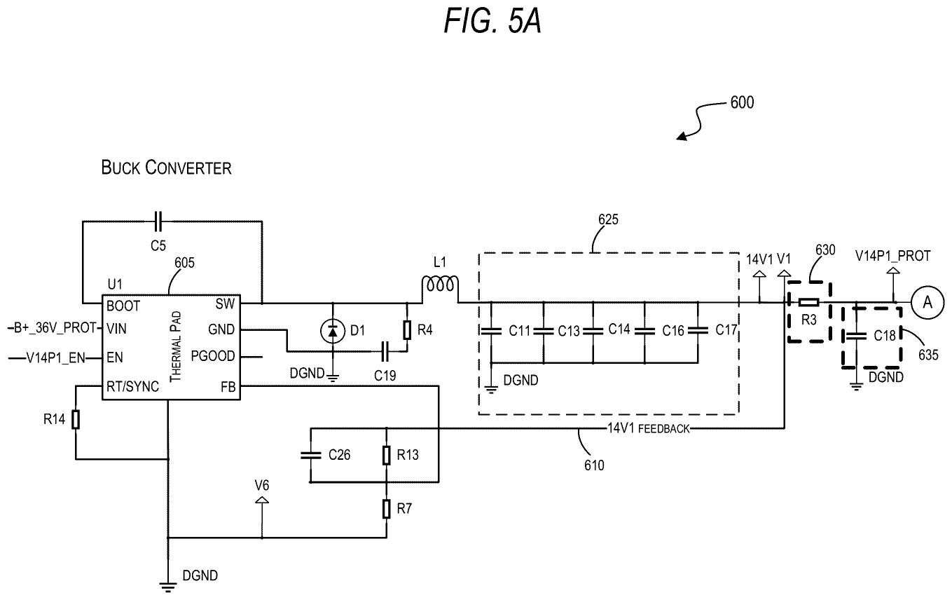

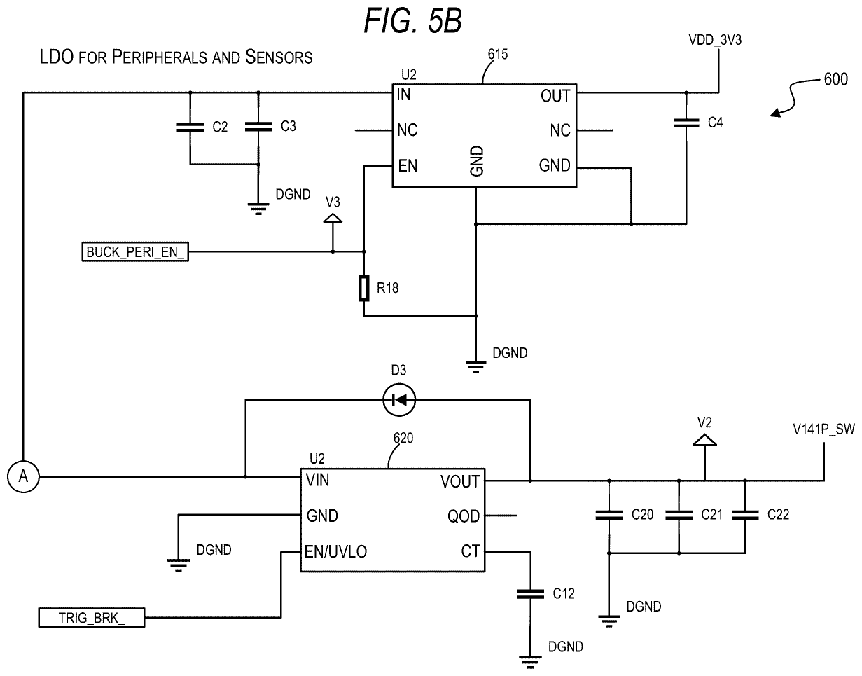

Referring to FIGS. 5A and 5B, another example circuit 600 for implementing the power management system of the present disclosure is depicted. The circuit 600 includes a switcher step down regulator or converter, for example, switcher step down regulator or converter 605. The circuit 600 elements in FIG. 5A can represent regulators and switches from FIG. 4. For example, the converter 605 can correspond to the SMPS 506 in FIG. 4. The quiescent current of the regulator can be low in sleep-mode such that it is suitable for battery pack powered systems. For example, the regulator can have a quiescent current of, for example, about 40 μA in a sleep mode, which can be further reduced in a shutdown mode to prolong battery life. The regulator can be connected to an inductor and a plurality of resistors and capacitors as depicted in FIG. 5A. In some embodiments, a capacitor (C26) and resistors (R7) and (R13) can be situated close to pin 5 (FB) of the regulator 605. The resistor (R13) connected at node “14V1_feedback” 610 can also be electrically connected to the node between capacitor (C17) and resistor (R3) such that it is the feedback path after the capacitors (C11, C13, C14, C16, C17).

Referring to FIG. 5B, in some embodiments, the circuit 600 also includes a voltage regulator with enable and a channel load switch, for example, voltage regulator 615 and load switch 620, respectively. The circuit 600 elements in FIG. 5B can correspond to the regulators and switches from FIG. 4. For example, the voltage regulator 615 can correspond to the voltage regulator 510, 512 and the load switch 620 can correspond to the high side switch 508. The voltage regulator can be a linear regulator with a low quiescent current, for example, a quiescent current of about 1 μA.

In some embodiments, the circuit 600 can include a bank of output filter capacitors 625 (i.e., C11, C13, C14, C16, C17) connected to and situated between the switcher step down regulator 605 (or SMPS 506) or converter and the voltage regulator 615 (e.g., a low dropout voltage regulator 510) and load switch 620 (or high side switch 508). The converter 605 is configured to maintain regulator stability at various load and environmental conditions, so the output capacitors should be low equivalent series resistance (“ESR”) capacitors. The general disadvantage of low-ESR capacitors, however, is that due to their architecture, they are not the preferred choice for buffer applications. Instead, for buffer applications, electrolytic capacitors are preferred. However, electrolytic capacitors tend to have significantly higher ESR and their ESR is also significantly impacted by aging and environmental conditions. In some embodiments, the bank of output filter capacitors 625 can be coupled to a resistor 630 and a buffer capacitor 635. The resistor 630 represents, from an ESR standpoint, a decoupling between SMPS 506, the bank of output filter capacitors 625, and the buffer capacitor 635. The buffer capacitor 635 is configured to handle high current peak loads that occur at a node 610 and the downstream loads. The node 610 between capacitor (C17) and resistor 630 represents the last point where the switcher step down regulator 605 is exposed to a low-ESR and is, therefore, able to regulate the output voltage with fast response and low ripple voltage.

Having the series resistor 630 allows the capacitor ESR fluctuation of capacitor 635 to not influence the stability of the switcher step down regulator 605 under varying load, environmental conditions, and due to part degradation. Thus, this combination of elements provides a significant advantage to implementations without the series resistor 630 between ceramic capacitors and the buffer capacitor after the switcher step down regulator 605. There are intrinsic limitations to the current consumption of previous circuits in standby/non-use modes that have attempted to optimize their idle/non-used current consumption. Specifically, previous circuits had the need to use exclusively ceramic capacitors, or accept the disadvantages introduced by directly connected ceramic capacitors and bulk capacitors. This would either drive the implementation cost up or causes the switcher step down regulator 605 to not be stable. The circuit 600 of the present disclosure provides an improvement to such deficiencies, among others.

In operation, the battery pack powered tool 100 can be loaded with one or more battery pack(s) 200, for example, in the battery pack receiving cavity 118. The one or more battery pack(s) 200 can provide power to the battery pack powered tool 100 and its various components. The battery pack(s) 200 can be in communication with the SMPS 506 which provides power to each of the sub circuits 502, 504 of the battery pack powered tool 100. For example, the voltage can be provided by the SMPS 506 to the first and second plurality of sub circuits 502, 504 through the high side switch 508 and the voltage regulator 510, respectively. The high side switch 508 can provide a voltage to the PWM drivers 450, memory 460, and indicators 430, while the voltage regulator 510 can provide a voltage to the sensors 425 and communication 410. There can also be a second voltage regulator 512 to power the processing unit 455 and trigger 150/switch 415. The power can be provided on demand based on activation of the battery pack powered tool 100, for example, actuation of the trigger 150.

To prevent the inserted battery pack(s) 200 from being depleted/damaged while connected to the battery pack powered tool 100, the power management systems described herein can be implemented to minimize the current consumption. The power management system of the present disclosure can reduce current consumption by implementing the circuit designs discussed with respect to FIGS. 4, 5A, and/or 5B. When the battery pack powered tool 100 is not in use, a combination of the processing unit 455 and trigger 150/switch 415 can send disable signals over one or more control lines to disable the respective sub circuits. Similarly, when the battery pack powered tool 100 is enabled, combinations of the processing unit 455 and trigger 150/switch 415 can send enable signals over one or more control lines to enable the respective sub circuits. As depicted in FIG. 4, the processing unit 455 can be coupled to control lines for the SMPS 506 and the voltage regulator 510. The trigger 150/switch 415 can be coupled to control lines for the high side switch 508 and a trigger line to the processing unit 455. Activation of the trigger 150/switch 415 can cause a signal to be sent to the processing unit 455 and the high side switch 508. In response to receiving a trigger signal, the processing unit 455 can send enable signals to the SMPS 506 and the voltage regulator 510.

In some embodiments, the SMPS 506, the voltage regulator 510, and the high side switch 508 can each have enable pins for individually activating or controlling their operation. If one of the SMPS 506, the voltage regulator 510, and the high side switch 508 is disabled, then a load from the connected PWM drivers 450, memory 460, indicators 430, sensors 425, and communication line 495 will be substantially or entirely stopped from drawing power from the battery pack(s) 200. If the SMPS 506 is disabled, then power will not be transmitted to either of the voltage regulator 510 or the high side switch 508, deactivating both plurality of sub circuits 502, 504.

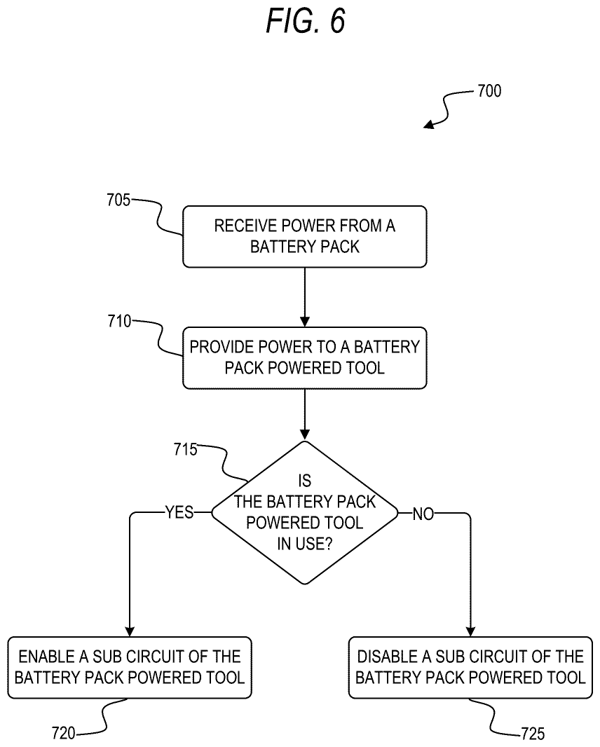

FIG. 6 illustrates a method 700 executed by the controller 400 of the battery pack powered tool 100. The controller 400 receives a voltage signal from the battery pack 200 and determines that a battery pack 200 is coupled to the battery pack powered tool 100 (STEP 705). The controller 400 provides power to the first plurality of sub circuits 502 and/or the second plurality of sub circuits 504 of the battery pack powered tool 100 (STEP 710). For example, the controller 400 transfers power from the battery pack(s) 200 to the components (e.g., PWM drivers, memory, indicators, sensors, communication, etc.) of the first and second plurality of sub circuits 502, 504. The controller 400 determines whether the battery pack powered tool 100 is in use (STEP 715). For example, when the controller 400 receives a signal from the trigger 150, the controller 400 determines that the trigger 150 is activated and that the battery pack powered tool 100 is in use. If, at STEP 715, the battery pack powered tool 100 is in use the first and second plurality of sub circuits 502, 504 of the battery pack powered tool can be enabled (STEP 720). When, for example, the controller 400 stops receiving a signal from the trigger 150, the controller 400 determines that the trigger 150 is not activated and the battery pack powered tool 100 is not in use. When the battery pack powered tool 100 is not in use, the first and second plurality of sub circuits 502, 504 of the battery pack powered tool can be disabled (STEP 725).

Although the disclosure has been described in detail with reference to certain preferred embodiments, variations and modifications exist within the scope and spirit of one or more independent aspects of the disclosure as described.

What is claimed is:

1. A power management system comprising:
a battery pack powered tool;
one or more battery packs coupled to the battery pack powered tool;
a first plurality of sub circuits including a switch and one or more first peripheral outputs;
a second plurality of sub circuits including a voltage regulator and one or more second peripheral outputs; and
one or more control lines for enabling or disabling the first plurality of sub circuits and the second plurality of sub circuits.

2. The system of claim 1, wherein the one or more battery packs include a first battery pack and a second battery pack.

3. The system of claim 1, wherein the first plurality of sub circuits includes the switch connected to at least one of a pulse width modulation (“PWM”) driver, a memory, or one or more indicators.

4. The system of claim 1, wherein the second plurality of sub circuits includes a low dropout (“LDO”) voltage regulator connected to at least one of a one or more sensors or a communication line.

5. The system of claim 1, further comprising a switched-mode power supply (“SMPS”) configured to provide power from the one or more battery packs to the first plurality of sub circuits and the second plurality of sub circuits.

6. The system of claim 5, wherein the SMPS is a buck converter.

7. The system of claim 1, further comprising:
a processing unit configured to control at least one of the one or more control lines for enabling or disabling the first plurality of sub circuits and the second plurality of sub circuits.

8. The system of claim 1, further comprising a control switch to control at least one of the one or more control lines for enabling or disabling the first plurality of sub circuits.

9. The system of claim 1, wherein enabling or disabling the first plurality of sub circuits and the second plurality of sub circuits reduces quiescent current of the battery powered tool to less than 7 micro-Amps.

10. The system of claim 1, further comprising:
one or more low equivalent series resistance (“ESR”) output capacitors;
a buffer capacitor; and
a series resistor connected between the ESR output capacitors and the buffer capacitor.

11. A method for managing power consumption of a battery pack powered tool, the method comprising:
receiving, with a controller, power from one or more battery packs, the one or more battery packs being coupled to the battery pack powered tool;
providing, with the controller, the power from the one or more battery packs to a first plurality of sub circuits of the battery pack powered tool, the first plurality of sub circuits including a switch and one or more first peripheral outputs;
providing, with the controller, the power from the one or more battery packs to a second plurality of sub circuits of the battery pack powered tool, the second plurality of sub circuits including a voltage regulator and one or more second peripheral outputs; and
controlling, with the controller, operation of the battery pack powered tool, to enable or disable the first plurality of sub circuits and the second plurality of sub circuits using one or more control lines.

12. The method of claim 11, wherein the one or more battery packs include a first battery pack and a second battery pack.

13. The method of claim 11, wherein the first plurality of sub circuits includes the switch connected to at least one of a pulse width modulation (“PWM”) driver, a memory, or one or more indicators.

14. The method of claim 11, wherein the second plurality of sub circuits includes a low dropout (“LDO”) voltage regulator connected to at least one of a sensor or a communication line.

15. The method of claim 11, wherein controlling operation of the battery pack powered tool includes:
controlling, with the controller, a switched-mode power supply (“SMPS”) to provide the power from the one or more battery packs to the first plurality of sub circuits and the second plurality of sub circuits.

16. The method of claim 15, wherein the SMPS is a buck converter.

17. The method of claim 11, wherein enabling or disabling the first plurality of sub circuits and the second plurality of sub circuits reduces quiescent current of the battery pack powered tool to less than 7 micro-Amps.

18. The method of claim 11, wherein controlling the operation of the battery pack powered tool includes:
determining, with the controller, that the battery pack powered tool is not in use; and
sending, with the controller, a control signal over the one or more control lines that disables the first plurality of sub circuits and the second plurality of sub circuits.

19. The method of claim 11, wherein controlling the operation of the battery pack powered tool includes:
determining, with the controller, that the battery pack powered tool is in use; and
sending, with the controller, a control signal over the one or more control lines that enables the first plurality of sub circuits and the second plurality of sub circuits.

20. A battery pack powered tool comprising:
a battery pack interface configured to receive a battery pack;
a first sub circuit including a switch and a first peripheral output;
a second sub circuit including a voltage regulator and a second peripheral output; and
one or more control lines configured to enable or disable the first sub circuit and/or the second sub circuit.
